(19) United States
(12) Patent Application Publication
(10) Pub. No.: US 2020/0171440 A1
(43) Pub. Date: Jun. 4, 2020

(54) METHOD FOR WASHING HOLLOW FIBER MEMBRANE MODULE AND HOLLOW FIBER MEMBRANE FILTRATION DEVICE

(71) Applicant: KURITA WATER INDUSTRIES LTD., Tokyo (JP)

(72) Inventor: Keijirou TADA, Tokyo (JP)

(21) Appl. No.: 16/088,337

(22) PCT Filed: Sep. 12, 2016
(86) PCT No.: PCT/JP2016/076827

§ 371 Date: Sep. 25, 2018

(30) Foreign Application Priority Data
Mar. 29, 2016 (JP) 2016-066000

(51) Int. Cl. B01D 65/02; C02F 1/44; B01D 63/04

(52) U.S. Cl. CPC B01D 65/02; C02F 2303/16; B01D 63/04; C02F 1/44

(57) ABSTRACT

A hollow fiber membrane filtration device includes a hollow fiber membrane module including a vessel having a treated water outlet and a concentrated water outlet; a plurality of hollow fiber membranes each of which separates raw water into permeated water and concentrated water, and is vertically disposed in the vessel; an upper end fixing member that fixes upper end parts of the hollow fiber membranes and is disposed at an upper part in the vessel; a permeated water chamber that is formed on an upper side of the upper end fixing member and communicates with an interior of each of the hollow fiber membranes; and a water conduit through which the raw water is supplied into the vessel. The water conduit vertically extends on a lower side of the upper end fixing member, and a plurality of ejection holes is provided on a side peripheral surface to eject raw water.

### TECHNICAL FIELD

The present invention relates to a method for washing a hollow fiber membrane module and a hollow fiber membrane filtration device, and particularly, relates to a method for washing a hollow fiber membrane module and a hollow fiber membrane filtration device that make it possible to sufficiently remove, by wash, suspended matter attached to a membrane.

### BACKGROUND ART

In fields such as pure water production and drainage water collection, a hollow fiber membrane module has been widely used as means for removing suspended matter components and organic matters. As a membrane of the hollow fiber membrane module, a microfiltration membrane (MF membrane), an ultrafiltration membrane (UF membrane) or the like is selectively used depending on separation objects. Generally, the former has a pore of around 0.1 μm, and the latter has a pore of 0.005 to 0.5 μm.

When large amounts of suspended matter and organic matter are contained in emulsified water that is supplied to the hollow fiber membrane module, the clogging of the membrane occurs, resulting in not only the increase in backwash frequency and chemical wash frequency but also the increase in membrane replacement frequency. For preventing the clogging of the membrane, a method involving decreasing the flow volume per unit area of the membrane is generally adopted, but this method has a problem of the increase in the number of membranes to be provided.

For reducing the pollution of the membrane, there is known a method involving performing a flocculation treatment step at a stage prior to the hollow fiber membrane module. However, the increase in suspended matter amount due to a flocculation agent causes the suspended matter pollution of the membrane. In such a situation, it is strongly demanded to establish a membrane module structure and backwash method for increasing the suspended matter removal performance of the membrane.

In Patent Literature 1, there is proposed a backwash method involving using air and water for enhancing the suspended matter removal performance of the membrane. However, in some cases, this method does not greatly enhance the suspended matter removal performance, depending on the kind and amount of the suspended matter, and a higher-performance backwash method is demanded.

In general air washes, air flows from a lower part of the membrane module to an upper part. However, since there is a vertical difference in the strength of the air, the air does not go through the whole of the membrane module, and some spots are insufficiently washed. When the drainage is performed at a lower part at the time of the air wash, the air is drained without penetrating the interior of the membrane module. Therefore, the drainage can be performed only at an upper part of the module, for example, at a circulation part. Accordingly, in some cases, the suspended matter peeled off from the whole of the membrane module by the air wash is attached to the upper part of the membrane.

In the case of a hollow fiber membrane in which only an upper end is fixed, there is a concern that a strong air wash causes kinking or folding of the hollow fiber membrane at a lower part of the membrane module.

### CITATION LIST

### Patent Literature

PTL1: JP 2005-88008 A

PTL2: JP 5-96136 A

PTL3: JP 2002-204930 A

### SUMMARY OF INVENTION

The present invention has been made in view of the above conventional circumstance, and has an object to provide a method for washing a hollow fiber membrane module and a hollow fiber membrane filtration device that make it possible to remove the suspended matter attached to the hollow fiber membrane evenly and sufficiently.

A method for washing a hollow fiber membrane module in the present invention is a method for washing a hollow fiber membrane module, the hollow fiber membrane module comprising: a vessel that comprises a treated water outlet and a concentrated water outlet; a water conduit through which raw water is supplied into the vessel; a plurality of hollow fiber membranes each of which separates the raw water into permeated water and concentrated water, each of the hollow fiber membranes being vertically disposed in the vessel; an upper end fixing member that fixes upper end parts of the hollow fiber membranes, the upper end fixing member being disposed at an upper part in the vessel; and a permeated water chamber that is formed on an upper side of the upper end fixing member, the permeated water chamber communicating with an interior of each of the hollow fiber membranes, wherein the water conduit vertically extends on a lower side of the upper end fixing member, and a plurality of ejection holes are provided on a side peripheral surface, each of the ejection holes being a hole through which the raw water is ejected, a drainage port is provided at a lower part of the vessel, the drainage port being a drainage port through which wash drainage water is drained, the wash drainage water being wash drainage water at time of performing a bubbling wash in which gas is injected from the plurality of ejection holes, wherein the bubbling wash in which the gas is injected from the plurality of ejection holes is performed, and the wash drainage water is drained from the drainage port.

In an aspect of the present invention, the hollow fiber membrane is fixed by only the upper end fixing member.

In an aspect of the present invention, the water conduit is provided so as to penetrate a bottom portion of the vessel and extend in the vessel.

In an aspect of the present invention, the drainage port is provided at a periphery of the water conduit.

In an aspect of the present invention, backwash in which backwash water is supplied from the treated water outlet is performed concurrently with the bubbling wash.

In an aspect of the present invention, a chemical is added to the backwash water.

In an aspect of the present invention, the wash drainage water is drained from the concentrated water outlet provided at an upper part of the vessel, before or after the wash drainage water is drained from the drainage port.

In an aspect of the present invention, a flow rate of the gas to pass through the water conduit is 100 to 300 NL/min.

A hollow fiber membrane filtration device according to the present invention comprises a hollow fiber membrane module, the hollow fiber membrane module comprising: a vessel that comprises a treated water outlet and a concentrated water outlet; a water conduit through which raw water is supplied into the vessel; a plurality of hollow fiber membranes each of which separates the raw water into permeated water and concentrated water, each of the hollow fiber membranes being vertically disposed in the vessel; an upper end fixing member that fixes upper end parts of the hollow fiber membranes, the upper end fixing member being disposed at an upper part in the vessel; and a permeated water chamber that is formed on an upper side of the upper end fixing member, the permeated water chamber communicating with an interior of each of the hollow fiber membranes, wherein the water conduit vertically extends on a lower side of the upper end fixing member, and a plurality of ejection holes are provided on a side peripheral surface, each of the ejection holes being a hole through which the raw water is ejected, a drainage port is provided at a lower part of the vessel, the drainage port being a drainage port through which wash drainage water is drained, the wash drainage water being wash drainage water at time of performing a bubbling wash in which gas is injected from the plurality of ejection holes, and a raw water pipe and gas introduction means are connected with the water conduit.

In an aspect of the present invention, the hollow fiber membrane is fixed by only the upper end fixing member.

In an aspect of the present invention, the water conduit is provided so as to penetrate a bottom portion of the vessel and extend in the vessel.

In an aspect of the present invention, the drainage port is provided at a periphery of the water conduit.

In an aspect of the present invention, the hollow fiber membrane filtration device comprises backwash means for supplying backwash water from the treated water outlet.

In an aspect of the present invention, the hollow fiber membrane filtration device comprises means for adding a chemical to the backwash water.

### ADVANTAGEOUS EFFECTS OF INVENTION

In the hollow fiber membrane filtration device according to the present invention, the water conduit vertically extends in the vessel, and the bubbling wash is performed by injecting the gas from the plurality of ejection holes provided on the water conduit. Therefore, it is possible to make the air go through the whole of the membrane module, and to remove the suspended matter attached to the hollow fiber membrane evenly and sufficiently.

### BRIEF DESCRIPTION OF DRAWINGS

FIG. 1 is a schematic diagram of a hollow fiber membrane filtration device according to an embodiment.

FIG. 2 is a schematic diagram of the hollow fiber membrane filtration device at the time of a filtration treatment.

FIG. 3 is a schematic diagram of the hollow fiber membrane filtration device at the time of a wash treatment.

FIG. 4 is a schematic diagram of the hollow fiber membrane filtration device at the time of a wash treatment.

FIG. 5 is a schematic diagram of a drainage port provided at a bottom part of a vessel.

FIG. 6 is a schematic diagram of a hollow fiber membrane filtration device according to another embodiment.

### DESCRIPTION OF EMBODIMENTS

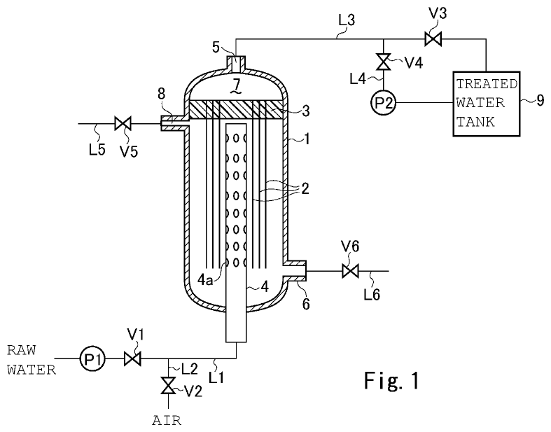

An embodiment will be described below with reference to FIG. 1 to FIG. 4.

FIG. 1 is a schematic diagram showing the configuration of a hollow fiber membrane filtration device comprising a hollow fiber membrane module according to the embodiment. As shown in FIG. 1, the hollow fiber membrane module comprises a vessel 1 disposed such that an axis line direction of a cylinder is a vertical direction (a perpendicular direction in the embodiment). In the vessel 1, a plurality of hollow fiber membranes 2 are disposed.

The hollow fiber membrane 2 is fixed by a potting member 3 as a fixing member, which is made of a synthetic resin, at an upper side of the vessel 1, and is not fixed at a lower side of the vessel 1. For example, an epoxy resin can be used as the synthetic resin of the potting member 3.

For example, the hollow fiber membrane 2 is put in a U-shape, and both ends of the hollow fiber membrane are fixed by the potting member 3. In this case, an intermediate part of the hollow fiber membrane 2 is positioned at a lower part of the vessel 1.

In the case of a hollow fiber membrane 2 in which one end is opened and the other end is sealed, the opened one end side of the hollow fiber membrane 2 is fixed by the potting member 3, and the sealed other end side is disposed at a lower part of the vessel 1.

The hollow fiber membrane 2 may be any of a UF membrane, an MF membrane and the like. The hollow fiber membrane 2 is not particularly limited, and typically, a hollow fiber membrane 2 having an inner diameter of about 0.2 to 1.0 mm, an outer diameter of about 0.5 to 2.0 mm and an effective length of about 300 to 2500 mm is used. Preferably, such hollow fiber membranes 2, the number of which is 500 to 70000, should be loaded in the vessel 1, such that the total membrane area is about 5 to 100 m². The membrane material of the hollow fiber membrane 2 is not particularly limited, and PVDF (polyvinylidene fluoride), polyethylene, polypropylene or the like can be used. In the embodiment, the hollow fiber membrane module comprising the hollow fiber membranes 2 will be described, but it is only necessary to be a membrane module using a tubular membrane.

A treated water chamber 7 is compartmentally formed on an upper side of the potting member 3. An upper end side of the hollow fiber membrane 2 penetrates the potting member 3, the opening of the upper end faces the treated water chamber 7, and the interior of the hollow fiber membrane 2 communicates with the treated water chamber 7. In the case where the hollow fiber membrane 2 is put in a U-shape, both ends of the hollow fiber membrane 2 penetrate the potting member 3.

The potting member 3 has a disk shape, for example, and the outer peripheral surface or outer edge part contacts with the inner surface of the vessel 1 in a watertight manner.

In the interior of the vessel 1, a water conduit 4 extends in a roughly vertical direction (an axial direction of the vessel 1). For example, the water conduit 4 is disposed along the central axis of the vessel 1. The water conduit 4 is a circular pipe in which a distal end (upper end) is closed, and on the side peripheral surface, a plurality of ejection holes 4a are wholly provided at intervals in the vertical direction and the circumferential direction. The number of the ejection holes 4a is not particularly limited, and for example, is about 5 to 50.

The height (the length in the vertical direction) of the water conduit 4 is not particularly limited. It is preferable that the upper end of the water conduit 4 is positioned near a lower surface of the potting member 3. The size and shape of the ejection hole 4a are not particularly limited. For example, a circular shape having a diameter of 5 to 50 mm is adopted. The inner diameter of the water conduit 4 is about 10 to 100 mm, for example. Further, the upper end of the water conduit may be buried in the potting member 3.

A lower part of the water conduit 4 is provided so as to penetrate a bottom portion of the vessel 1 and extends to the exterior of the vessel 1. A raw water pipe L1 is connected with the water conduit 4, and a pump P1 and a valve V1 are provided on the raw water pipe L1. An air introduction pipe L2 branches from the raw water pipe L1, and a valve V2 is provided on the air introduction pipe L2.

The opening and closing of the valve V1 and the valve V2 are switched, and thereby, the supply of the raw water/air to the vessel 1 can be switched. The valve V1 is opened and the valve V2 is closed, so that the raw water is fed through the raw water pipe L1 by the pump P1. Thereby, it is possible to eject the raw water from the ejection holes 4a on the water conduit 4 in a radial direction, and to supply the raw water into the vessel 1.

The valve V1 is closed and the valve V2 is opened, so that the air is supplied from the air introduction pipe L2. Thereby, it is possible to eject bubbles from the ejection holes 4a of the water conduit 4 in the radial direction, and to perform a bubbling wash. The valves V1, V2 are opened, and thereby, it is possible to eject gas-liquid mixture from the ejection holes 4a.

An outlet 5 for treated water (membrane permeated water) is provided at a top part of the vessel 1. Further, a concentrated water outlet 8 is provided at an upper part of the side surface of the vessel 1. The concentrated water outlet 8 is provided near the lower surface of the potting member 3. It is preferable that the distance from the potting member 3 to an upper edge of the concentrated water outlet 8 be about 0 to 30 mm, particularly, about 0 to 10 mm. A pipe L5 is connected with the concentrated water outlet 8, and a valve V5 is provided on the pipe L5.

A drainage port 6 is provided at a lower part of the side surface of the vessel 1. The drainage port 6 is provided near the bottom portion of the vessel 1. A pipe L6 is connected with the drainage port 6, and a valve V6 is provided on the pipe L6.

A treated water removing pipe L3 is connected with the treated water outlet 5, and the treated water (membrane permeated water) is drained through the treated water removing pipe L3. The treated water is stored in a treated water tank 9.

With the treated water removing pipe L3, a backwash water pipe L4 is connected at a position between a valve V3 provided on the treated water removing pipe L3 and the treated water outlet 5. A valve V4 is provided on the backwash water pipe L4. The valve V3 is closed and the valve V4 is opened, so that backwash water flows from treated water outlet 5 to the vessel 1 through the backwash water pipe L4 by the pump P2. Thereby, it is possible to perform the backwash of the hollow fiber membrane 2. FIG. 1 shows a configuration in which the backwash water pipe L4 is connected with the treated water tank 9 and the treated water is used as the backwash water, but the backwash water may be the raw water.

The drainage water due to the wash may be drained from the drainage port 6 through the pipe L6, or may be drained from the concentrated water outlet 8 through the pipe L5. The drainage from the drainage port 6 and the drainage from the concentrated water outlet 8 may be performed in turn (alternately).

Chemical adding means (not illustrated) for adding a chemical to the backwash water that flows through the backwash water pipe L4 may be provided. The chemical to be added is sodium hypochlorite, a strong alkaline agent, a strong acid agent, or the like, and is selected depending on the membrane-attached matter. For example, in the case where the membrane-attached matter is an organic matter, a suspended matter containing an organic matter or the like, it is preferable that sodium hypochlorite be added so as to remain at 0.05 to 0.3 mgCl₂/L.

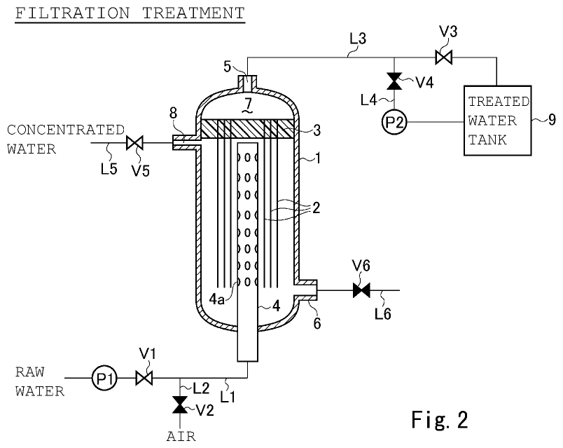

In a filtration treatment by the hollow fiber membrane filtration device, as shown in FIG. 2, the valves V1, V3, V5 are opened, the valves V2, V4, V6 are closed, the pump P1 is actuated, and the raw water is supplied from the water conduit 4. The permeated water that is of the raw water supplied from the water conduit 4 and that permeates the hollow fiber membrane 2 is taken out from the treated water outlet 5, as the treated water, and is stored in the treated water tank 9 through the treated water removing pipe L3.

The concentrated water that does not permeate the hollow fiber membrane 2 is drained from the concentrated water outlet 8 through the pipe L5. The drained concentrated water may be circulated so as to be mixed in the raw water and be supplied to the vessel 1.

The hollow fiber membrane filtration device shown in FIG. 1 performs the filtration treatment by an external pressure method involving passing the raw water to the outside of the hollow fiber membrane 2 in a cross-flow technique.

When the filtration treatment is continuously performed, the suspended matter accumulates in the hollow fiber membrane 2. Hence, a wash treatment for removing the suspended matter trapped in the hollow fiber membrane 2 is performed after the filtration treatment is performed for a predetermined time or when the treated water amount has been decreased.

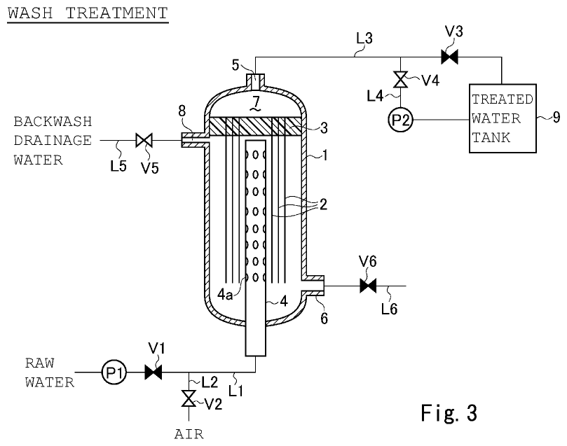

In the wash treatment of hollow fiber membrane filtration device, as shown in FIG. 3, the valves V1, V3, V6 are closed, the valves V2, V4, V5 are opened, and the air is injected from the water conduit 4 to the vessel 1, so that the bubbling is performed. Further, the pump P2 is actuated, and the backwash water is fed into the hollow fiber membrane 2 through the treated water chamber 7, so that the backwash is performed. It is preferable that the amount of the air to be supplied from the water conduit 4 be about 30 to 500 NL/min, particularly, 100 to 300 NL/min. A chemical may be added to the backwash water. The wash drainage water is drained from the concentrated water outlet 8 to the exterior of the system through the pipe L5. In this wash treatment, the bubbling wash and the backwash are performed concurrently.

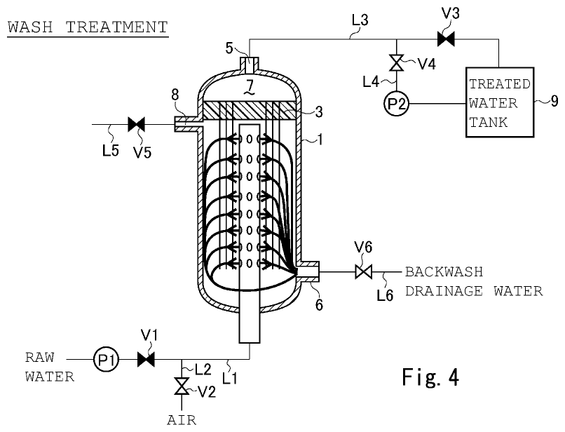

As shown in FIG. 4, at the time of the wash treatment, the valve V6 may be opened, and the valve V5 may be closed. In this case, the wash drainage water is drained from the drainage port 6. In FIG. 4, arrows show a flow along which the air ejected from the water conduit 4 is drained from the drainage port 6 together with the backwash water.

After the drainage of the backwash water from the drainage port 6 shown in FIG. 4 is performed for a predetermined time, the valve V6 may be closed, the valve V5 is opened, and the backwash water may be drained from the concentrated water outlet 8, as shown in FIG. 3.

Since many ejection holes 4a are provided on the water conduit 4 over the whole in the vertical direction, it is possible to inject bubbles to the whole of the hollow fiber membrane 2 including the hollow fiber membrane 2 near the upper end fixing member (near the potting member 3), and to remove the suspended matter by the wash evenly and sufficiently. Even when the air amount at the time of the bubbling wash is increased, it is possible to prevent kinking and folding of the hollow fiber membrane 2, compared to the method in which the air flows from a lower part of the module to an upper part.

By performing the drainage of the backwash water from the drainage port 6 and the drainage of the backwash water from the concentrated water outlet 8 in turn, it is possible to drain efficiently the suspended matter peeled off from the hollow fiber membrane 2.

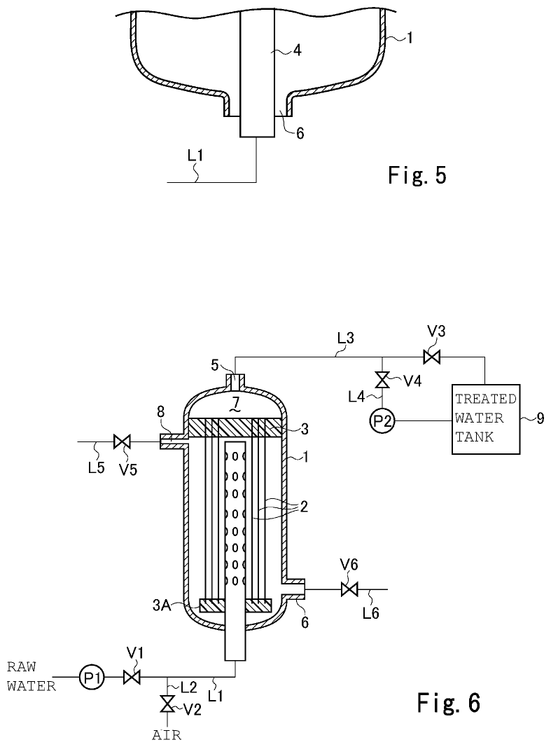

The drainage port 6 may be provided at a bottom part of the vessel 1. For example, as shown in FIG. 5, at the bottom part of the vessel 1, the periphery of the water conduit 4 is the drainage port 6.

As shown in FIG. 6, both of the upper and lower ends of the hollow fiber membrane 2 may be fixed. The lower end of the hollow fiber membrane 2 is buried and sealed in a potting member 3A. A through-hole through which the water conduit 4 passes is provided at a central part of the potting member 3A.

The backwash may be an air backwash, instead of the water backwash. In the bubbling wash, gas-liquid mixture may be supplied from the water conduit 4, instead of the air.

The above embodiments are examples of the present invention, and the present invention may be configured as an embodiment other than the illustrated embodiments.

### EXAMPLES

### Example 1

The filtration treatment was performed by passing the raw water through the water conduit 4 to the hollow fiber membrane filtration device comprising the hollow fiber membrane module shown in FIG. 1 for 30 minutes. Tap water was stored in a raw water tank, and 10 mg/L bentonite and 5 mg/L sodium humate were added. Thereafter, the pH was adjusted at 8.0 by sodium bicarbonate manufactured by Kishida Chemical Co., Ltd. and sulfuric acid manufactured by Kishida Chemical Co., Ltd. The water was fed from the raw water tank to a flocculation tank by a pump, and the residence time was 10 minutes. As the raw water, a water resulting from adding 100 mg/L industrial ferric chloride (concentration 38%) before the flocculation tank was used. The configuration of the hollow fiber membrane module is shown as follows.

Vessel 1: inner diameter 200 mm, height 1300 mm

Hollow fiber: inner diameter 0.75 mm, outer diameter 1.25 mm, polyvinylidene fluoride UF membrane with an effective length of 990 mm, membrane area 30 m²

Water conduit 4: length extending in the vessel 1 1000 mm, inner diameter 20 mm, outer diameter 25 mm

Ejection hole 4a: diameter 10 mm, 10 holes.

After the filtration treatment, the bubbling wash was performed by supplying the air from the water conduit 4, and the backwash was performed. The wash treatment was performed for 1 minute. The backwash water was drained from the concentrated water outlet 8. The supply amount of the air for bubbling was 80 NL/min. The supply amount of the backwash water was 80 L/min, and the filtration treated water was used as the supply water for the backwash.

The filtration treatment and the wash treatment were alternately performed five times for each treatment. The drained backwash water was taken in each cycle, and the suspended matter amount in the backwash water was measured. Table 1 shows the amount (suspended matter removal rate) of the suspended matter drained by the backwash to the total amount of the suspended matter supplied during five cycles.

### Example 2

The same treatment as Example 1 was performed except that the backwash water was drained from the drainage port 6. The measurement result is shown in Table 1.

### Example 3

The same treatment as Example 1 was performed except that the backwash water was drained from the drainage port 6 and thereafter was drained from the concentrated water outlet 8. The measurement result is shown in Table 1.

### Example 4

The same treatment as Example 3 was performed except that the supply amount of the air for bubbling was 150 NL/min. The measurement result is shown in Table 1.

### Example 5

The same treatment as Example 4 was performed except that sodium hypochlorite was added to the backwash water such that the concentration was 300 mgCl₂/L. The measurement result is shown in Table 1.

### Comparative Example 1

The same treatment as Example 1 was performed except that a hollow fiber membrane module in which the water conduit 4 was not provided was used and the bubbling wash was not performed. The measurement result is shown in Table 1.

### Comparative Example 2

The same treatment as Comparative Example 1 was performed except that the air for bubbling was supplied at 80 NL/min from a lower part of the vessel of the hollow fiber membrane module in the backwash. The measurement result is shown in Table 1.

### Comparative Example 3

The same treatment as Comparative Example 2 was performed except that the lower end of the hollow fiber membrane was fixed by being buried in the potting member. The measurement result is shown in Table 1.

TABLE 1

| | Suspended Matter Removal Rate |
|---|---|
| | % |
| Example 1 | 68 |
| Example 2 | 72 |
| Example 3 | 76 |
| Example 4 | 86 |
| Example 5 | 96 |
| Comparative Example 1 | 61 |
| Comparative Example 2 | 62 |
| Comparative Example 3 | 56 |

In Example 1, the suspended matter removal rate was higher compared to Comparative Example 1 in which the water conduit 4 was not provided.

In Example 1 in which the air was introduced from the water conduit 4, the suspended matter removal rate was higher than in a case where the air was introduced from the lower part of the vessel of the hollow fiber membrane module as shown in Comparative Example 2.

In Example 2 in which the backwash water was drained from the drainage port 6 at the lower part of the vessel 1, the suspended matter removal performance was higher than in Example 1 in which the backwash water was drained from the concentrated water outlet 8 at the upper part of the vessel 1.

In Example 3 in which the drainage of the backwash water from the drainage port 6 and the drainage of the backwash water from the concentrated water outlet 8 were performed in turn, the suspended matter removal performance was higher than in Examples 1, 2.

From Example 4, it was confirmed that the suspended matter removal performance was enhanced by increasing the supply amount of the air for bubbling.

From Example 5, it was confirmed that the suspended matter removal performance was enhanced by adding sodium hypochlorite to the backwash water.

It was confirmed that Comparative Example 2 in which only the upper end of the hollow fiber membrane was fixed exhibits a higher suspended matter removal performance than Comparative Example 3 in which both of the upper and lower ends of the hollow fiber membrane were fixed.

The present invention has been described in detail, using the particular aspects. It is obvious to those in the art that various modifications can be made without departing from the intention and scope of the present invention.

The present application is based on Japanese Patent Application No. 2016-066000 filed on Mar. 29, 2016, which is incorporated by reference in its entirety.

### REFERENCE SIGNS LIST

1 Vessel

2 Hollow fiber membrane

3 Potting member

4 Water conduit

5 Treated water outlet

6 Drainage port

7 Treated water chamber

8 Concentrated water outlet

9 Treated water tank

1. A method for washing a hollow fiber membrane module, the hollow fiber membrane module comprising:
a vessel that comprises a treated water outlet and a concentrated water outlet;
a water conduit through which raw water is supplied into the vessel;
a plurality of hollow fiber membranes each of which separates the raw water into permeated water and concentrated water, each of the hollow fiber membranes being vertically disposed in the vessel;
an upper end fixing member that fixes upper end parts of the hollow fiber membranes, the upper end fixing member being disposed at an upper part in the vessel; and
a permeated water chamber that is formed on an upper side of the upper end fixing member, the permeated water chamber communicating with an interior of each of the hollow fiber membranes, wherein
the water conduit vertically extends on a lower side of the upper end fixing member, and a plurality of ejection holes are provided on a side peripheral surface, each of the ejection holes being a hole through which the raw water is ejected,
a drainage port is provided at a lower part of the vessel, the drainage port being a drainage port through which wash drainage water is drained, the wash drainage water being wash drainage water at time of performing a bubbling wash in which gas is injected from the plurality of ejection holes, wherein
the bubbling wash in which the gas is injected from the plurality of ejection holes is performed, and the wash drainage water is drained from the drainage port.

2. The method for washing the hollow fiber membrane module according to claim 1, wherein the hollow fiber membrane is fixed by only the upper end fixing member.

3. The method for washing the hollow fiber membrane module according to claim 1, wherein the water conduit is provided so as to penetrate a bottom portion of the vessel and extend in the vessel.

4. The method for washing the hollow fiber membrane module according to claim 3, wherein the drainage port is provided at a periphery of the water conduit.

5. The method for washing the hollow fiber membrane module according to claim 1, wherein backwash in which backwash water is supplied from the treated water outlet is performed concurrently with the bubbling wash.

6. The method for washing the hollow fiber membrane module according to claim 5, wherein a chemical is added to the backwash water.

7. The method for washing the hollow fiber membrane module according to claim 1, wherein the wash drainage water is drained from the concentrated water outlet provided at an upper part of the vessel, before or after the wash drainage water is drained from the drainage port.

8. The method for washing the hollow fiber membrane module according to claim 1, wherein a flow rate of the gas to pass through the water conduit is 100 to 300 NL/min.

9. A hollow fiber membrane filtration device comprising a hollow fiber membrane module, the hollow fiber membrane module comprising:
a vessel that comprises a treated water outlet and a concentrated water outlet;
a water conduit through which raw water is supplied into the vessel;
a plurality of hollow fiber membranes each of which separates the raw water into permeated water and concentrated water, each of the hollow fiber membranes being vertically disposed in the vessel;
an upper end fixing member that fixes upper end parts of the hollow fiber membranes, the upper end fixing member being disposed at an upper part in the vessel; and
a permeated water chamber that is formed on an upper side of the upper end fixing member, the permeated water chamber communicating with an interior of each of the hollow fiber membranes, wherein
the water conduit vertically extends on a lower side of the upper end fixing member, and a plurality of ejection holes are provided on a side peripheral surface, each of the ejection holes being a hole through which the raw water is ejected,
a drainage port is provided at a lower part of the vessel, the drainage port being a drainage port through which wash drainage water is drained, the wash drainage water being wash drainage water at time of performing a bubbling wash in which gas is injected from the plurality of ejection holes, and
a raw water pipe and gas introduction means are connected with the water conduit.

10. The hollow fiber membrane filtration device according to claim 9, wherein the hollow fiber membrane is fixed by only the upper end fixing member.

11. The hollow fiber membrane filtration device according to claim 9, wherein the water conduit is provided so as to penetrate a bottom portion of the vessel and extend in the vessel.

12. The hollow fiber membrane filtration device according to claim 11, wherein the drainage port is provided at a periphery of the water conduit.

13. The hollow fiber membrane filtration device according to claim 9, comprising backwash means for supplying backwash water from the treated water outlet.

14. The hollow fiber membrane filtration device according to claim 13, comprising means for adding a chemical to the backwash water.
